(19) United States
(12) Patent Application Publication
(10) Pub. No.: US 2025/0244156 A1
(43) Pub. Date: Jul. 31, 2025

(54) SYSTEMS AND METHODS FOR DETECTING A CRYOGENIC FLUID LEVEL IN A CONTAINER

(71) Applicant: AmericanPharma Technologies, Inc., Boise, ID (US)

(72) Inventors: Michael R. Rusnack, Meridian, ID (US); Casey A. Harris, Las Vegas, NV (US)

(21) Appl. No.: 19/065,898

(22) Filed: Feb. 27, 2025

Related U.S. Application Data
(63) Continuation-in-part of application No. 17/821,750, filed on Aug. 23, 2022, now abandoned.
(60) Provisional application No. 63/559,123, filed on Feb. 28, 2024.

(51) Int. Cl. G01F 23/24

(52) U.S. Cl. CPC G01F 23/246

(57) ABSTRACT

Embodiments disclosed relate to systems and methods for detecting a cryogenic fluid level in a container. In an embodiment, a system includes a plurality of sensors and a controller. Each sensor of the plurality of sensors is configured to detect a property relating to a phase of cryogenic fluid. The plurality of sensors are coupled together and vertically spaced from one another when positioned in the container. The controller coupled to the plurality of sensors and configured to determine an approximate cryogenic fluid level in the container based on a single measurement derived from the plurality of sensors.

### CROSS-REFERENCE TO RELATED APPLICATIONS

This application is a continuation-in-part of U.S. patent application Ser. No. 17/821,750 filed on Aug. 23, 2022, which is incorporated herein by reference in its entirety. This application also claims priority to U.S. Provisional Patent Application No. 63/559,123 filed on Feb. 28, 2024, which is incorporated herein by reference in its entirety.

### FIELD OF THE INVENTION

This application generally relates to devices and systems configured to detect a level of cryogenic fluid in a container at a selected time, and related methods of detecting the level of cryogenic fluid in the container at a selected time.

### BACKGROUND

Regulatory requirements mandate the measurement of the cryogenic fluid level within the industry of cryogenic storage. Manual measurement is the most common methodology to measure a level of cryogenic fluid in a container. A steel meter stick is inserted into the bottom of the container and removed, with the frost line on the steel stick indicating the depth of the cryogenic fluid. Typically, the data is then manually recorded. This operation is repeated at regular intervals per the published requirements. The presence of cryogenic fluid may be recorded by immersing a measurement probe below the fluid level. The data presented by this measurement system typically records the observations that the probe is immersed in cryogenic fluid or in the presence of the cryogenic vapor. A measurement device capable of discerning the change in the level of the cryogenic fluid that is easily employed with reasonable accuracy is needed.

### SUMMARY

Embodiments disclosed herein include systems and methods for detecting a cryogenic fluid level in a container. In an embodiment, a system includes a sensing device and a controller. The sensing device includes a sensing device including a tube having a plurality of sensors disposed therein. Each sensor of the plurality of sensors is configured to detect a property relating to a phase of cryogenic fluid, the plurality of sensors being coupled together and vertically spaced from one another when positioned in the container. The tube includes a metal, stainless steel, and/or non-corrosive material that encloses the plurality of sensors effective to prevent cryogenic fluid from contacting the plurality of sensors and is configured to distribute a cold temperature (e.g., a cold thermal energy) along a length of the tube and act as a temperature buffer between the cryogenic fluid and the plurality of sensors when the tube is positioned within the cryogenic fluid. The controller is coupled to the sensing device and configured to determine an approximate cryogenic fluid level in the container based on a single measurement derived from the plurality of sensors.

In an embodiment, a method for detecting a cryogenic fluid level in a container is described. The method includes detecting, with a sensing device, a property relating to a phase of cryogenic fluid, the sensing device including a plurality of sensors coupled together and vertically spaced from one another within a tube positioned in the container. The tube prevents the cryogenic fluid from contacting the plurality of sensors, distributes a cold temperature (e.g., a cold thermal energy) along a length of the tube, and acts as a buffer between the cryogenic fluid and the plurality of sensors positioned therein. The method includes determining, with a controller coupled to the plurality of sensors, a cryogenic fluid level in the container based on a single measurement derived from the plurality of sensors.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views, or embodiments shown in the drawings.

FIGS. 1 and 2 are diagrams of a system for detecting a cryogenic fluid level in a container, according to an embodiment.

FIG. 3A is a diagram of a sensing device having a plurality of resistance temperature detectors in a series circuit, according to an embodiment.

FIG. 3B is a diagram of a sensing device having a plurality of resistance temperature detectors in a parallel circuit, according to an embodiment.

FIG. 3C is a diagram of a sensing device having a plurality of thermocouples in a series circuit, according to an embodiment.

FIG. 4 is a flow diagram for detecting a cryogenic fluid level in a container, according to an embodiment.

FIG. 5 is a block diagram of a controller, according to an embodiment.

FIG. 6 is a graph of the reported depth of a cryogenic fluid using the system of FIGS. 1 and 2, according to an embodiment.

### DETAILED DESCRIPTION

Systems and methods described herein may be utilized to automatically monitor, record, and/or provide an alert related to the storage conditions for products stored under cryogenic conditions. In some systems and methods, a cryogenic fluid (e.g., nitrogen, helium, argon, methane, or carbon monoxide) is stored in a container (e.g., Dewar). In order to protect the contents of the container in the event of damage or other failure of the container, regulatory bodies often require monitoring of a continuous temperature measurement of the cryogenic fluid and an active level of the cryogenic fluid in the container to ensure the integrity of the container. In conventional systems, a cryogenic fluid level in a container is regularly measured using a meter stick. Conventional systems and methods for measuring cryogenic fluid in a container have not met industry requirements while maintaining reliability.

In many embodiments disclosed herein, a sensing device and controller are configured to provide both the continuous temperature measurement of a cryogenic fluid and also an active level of the cryogenic fluid in the container. Thus, many embodiments disclosed herein provide a dual function of the sensing device to provide an accurate representation of the level and temperature of the cryogenic fluid. Systems and methods described herein provide a cost-effective and efficient solution to determine a cryogenic fluid level in a container by utilizing different properties of the cryogenic fluid at the liquid phase or the vapor phase. For example, the liquid phase and vapor phase of cryogenic fluid can be differentiated by temperature, resistance, and/or voltage. In some embodiments, the physical characteristics of the liquid phase and vapor phase of cryogenic fluids is utilized by regularly and vertically spacing cascaded measurement sensors in a container holding the cryogenic fluid. A controller is coupled to the cascaded measurement sensors and configured to view the cascaded measurement sensors as a single sensor providing a single measurement. For example, the cascaded measurement sensors may be arranged in at least one of a series circuit, a parallel circuit, or a series-parallel circuit.

The cascaded measurement sensors are physically spaced within the container. Because the positions of the sensors in the container is known or predetermined, the position of the cryogenic fluid also may be determined relative to the sensors. In some embodiments, systems and methods may include a probe shell (e.g., a tube) in which the cascaded measurement sensors are disposed at equal distances from adjacent sensors. Wiring of the cascaded measurement sensors emerges from cascaded measurement sensors and/or the probe shell (e.g., a tube) as a single sensor measurement. In some embodiments, the single sensor measurement produced by the cascaded measurement sensors is in response to a temperature difference between the liquid phase and the vapor phase of the measured cryogenic fluid at each sensor of the cascaded measurement sensors.

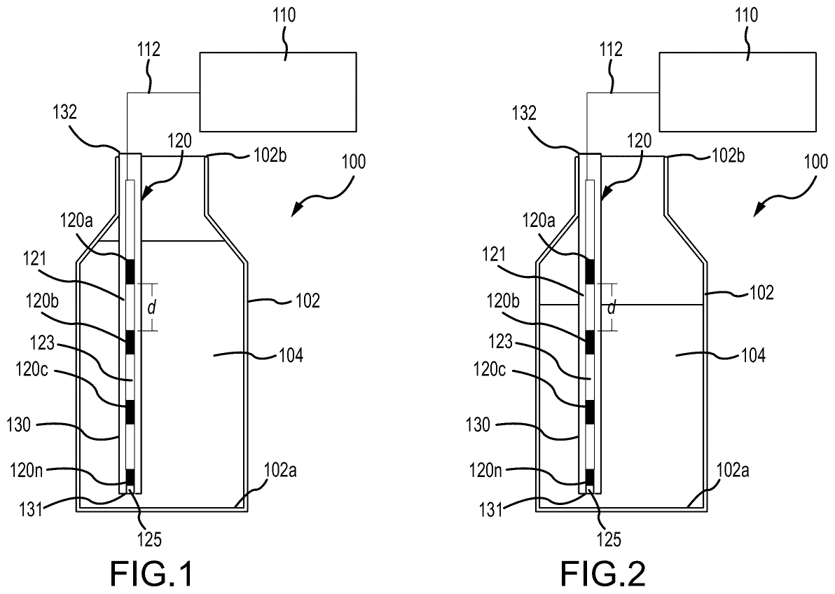

FIGS. 1 and 2 show diagrams of a system 100 for detecting a cryogenic fluid 104 level in a container 102, according to an embodiment. The system 100 may include a sensing device 120 and a controller 110 coupled to the sensing device. The container 102 may include any container for storing or holding cryogenic fluid and/or items to be stored in a cryogenic environment, such as a Dewar. The container 102 according to various embodiments may be sized and dimensioned to hold varying volumes of cryogenic fluid, such as about 10 L to about 600 L, about 10 L to about 50 L, about 50 L to about 100 L, about 100 L to about 150 L, about 150 L to about 200 L, about 200 L to about 250 L, about 250 L to about 300 L, about 300 L to about 350 L, about 350 to about 400 L, about 400 L to about 450 L, about 450 L to about 500 L, about 500 L to about 550 L, or about 550 L to about 600 L of cryogenic fluid. The cryogenic fluid 104 may include any cryogenic fluid, such as one or more of nitrogen, helium, argon, methane, or carbon monoxide.

The sensing device 120 includes a plurality of sensors, each sensor 120a, 120b, 120c, 120n of the plurality of sensors configured together to provide a single measurement, according to an embodiment. The plurality of sensors may be coupled to one another via a wire 112 in a circuit to provide a single measurement to the controller 110. The system 100 also may include a printed circuit assembly (PCA) 123 configured as an attachment medium for the sensors 120a, 120b, 120c, 120n. The PCA 123 also may provide a conduction path from the wire 112 to the sensors 120a, 120b, 120c, 120n, thereby allowing the wiring 112 to interface with the sensors 120a, 120b, 120c, 120n and/or the controller 110. The wiring 112 may include an interconnect cable. In some embodiments, the sensing device 120 also may include a specific temperature sensing element 125 disposed at the distal end 131 of the tube 130 of the sensing device 120.

In the system 100 shown in FIGS. 1 and 2, the sensing device 120 includes four sensors. In some embodiments, the sensing device 120 of the system 100 includes at least two sensors (e.g., two, three, four, five, six, seven, eight, nine, ten, etc., sensors). Each sensor 120a, 120b, 120c, 120n of the plurality of sensors in the sensing device 120 is configured to detect a property relating to a phase of cryogenic fluid 104. For example, each sensor 120a, 120b, 120c, 120n of the plurality of sensors in the sensing device 120 may be configured to sense a property relating to the cryogenic fluid 104 that changes when the cryogenic fluid 104 transitions between a liquid phase and a vapor phase. The level of the cryogenic fluid 104 in the container may be detected by the plurality of sensors in the sensing device 120 detecting the transition of the cryogenic fluid 104 from the liquid phase to a vapor phase (e.g., each sensor 120a, 120b, 120c, 120n detecting or otherwise sensing a property relating to the cryogenic fluid 104 in the liquid phase or a property relating to the cryogenic fluid 104 in the vapor phase).

In many embodiments, each sensor 120a, 120b, 120c, 120n of the plurality of sensors in the sensing device 120 is spaced an equal distance d from an adjacent sensor of the plurality of sensors. The plurality of sensors in the sensing device 120 are coupled together and vertically spaced from one another when positioned in the container 102. By utilizing multiple sensors in the sensing device 120 spaced a fixed and/or equal distance apart, the level changes in the cryogenic fluid 104 can be determined and recorded. The transition of the cryogenic fluid 104 from the liquid phase to the vapor phase from one sensor to an adjacent sensor may be measured by, for example, the temperature recorded by each sensor 120a, 120b, 120c, 120n of the plurality of sensors in the sensing device 120. The plurality of sensors in the sensing device 120 are configured to produce a single measurement of the property detected by each sensor 120a, 120b, 120c, 120n of the plurality of sensors. As the positions of the sensors 120a, 120b, 120c, 120n in the container 102 are known or predetermined, the position of the cryogenic fluid 104 also can be determined relative to the sensors 120a, 120b, 120c, 120n as the cryogenic fluid transitions from a liquid phase to a vapor phase. In some embodiments, the plurality of sensors are disposed within a tube 130 at equal distances from one another.

Each sensor 120a, 120b, 120c, 120n may be spaced an equal and/or predetermined distance d from adjacent sensor(s) of the plurality of sensors. In some embodiments, each sensor 120a, 120b, 120c, 120n may be spaced from adjacent sensors about 0.5 inch to about 10 inches, about 0.5 to about 5 inches, about 5 inches to about 10 inches, about 0.5 inches to about 2.5 inches, about 2.5 inches to about 5 inches, about 5 inches about 7.5 inches, about 7.5 inches to about 10 inches, about 0.5 inch to about 1.5 inches, about 1.5 inches to about 2.5 inches, about 2.5 inches to about 3.5 inches, about 3.5 inches to about 4.5 inches, about 1 inch, about 2 inches, about 3 inches, about 4 inches, about 5 inches, about 6 inches, about 7 inches, about 8 inches, about 9 inches, 10 inches, less than about 10 inches, less than about 7.5 inches, less than about 5 inches, or less than about 2.5 inches.

In some embodiments, the plurality of sensors are disposed within a tube 130 or shell at equal distances from one another. The tube 130 may include stainless steel, metal, and/or other non-corrosive material. In many embodiments, the tube 130 includes a material (such as the stainless steel) that is conductive (e.g., highly conductive in some instances). The material and the configuration of the tube 130 acts as a buffer between the cryogenic fluid 104 and the plurality of sensors disposed within the tube 130. Accordingly, the tube 130 is configured to distribute the cold temperature (e.g., the cold thermal energy) of the cryogenic fluid 104 throughout a length of the tube 130. For example, the tube 130 may more uniformly distribute the cold temperature (e.g., cold thermal energy) among the plurality of sensors, thereby allowing the controller to more accurately determine a depth of the cryogenic fluid 104 using the single measurement of the plurality of sensors. For example, the buffering and distribution imparted by the tube 130 on the plurality of sensors may result in a single measurement that is continuously changing or changing more often than the single measurement in conventional systems that only changes when the cryogenic fluid level drops below one sensor of the plurality of sensors.

The tube 130 may be configured to allow or facilitate the desired spacing of the sensors 120a, 120b, 120c, 120n and/or to protect the sensors 120a, 120b, 120c, 120n from damage during handling. The tube 130 also may encapsulate one or more printed circuit boards of the printed circuit assembly, protecting the one or more printed circuit boards from damage during handling and/or use. In many embodiments, the tube 130 encloses the sensors 120a, 120b, 120c, 120n such that the cryogenic fluid 104 does not enter the tube and does not contact the sensors 120a, 120b, 120c, 120n (e.g., the tube 130 prevents the cryogenic fluid 104 from directly contacting the sensors 120a, 120b, 120c, 120n). The tube 130 may include an outer layer of the stainless steel, metal, and/or other non-corrosive material and a core having the sensors 120a, 120b, 120c, 120n positioned therein. In some embodiments, the tube 130 may include a generally circular cross-sectional profile. In other embodiments, however, the tube 130 may include other cross-sectional profiles such as an oval, triangle, square, rectangle, or other polygonal profiles.

In some embodiments, the sensors 120a, 120b, 120c, 120n are positioned within an interior region of the tube 130. For example, a PCA 123 having the sensors 120a, 120b, 120c, 120n attached thereto may be positioned within the interior region of the tube 130. The interior region of the tube 130 may be filled with a filler material 121 to form the core of the tube 130 having the filler material 121, the PCA 123, and the sensors 120a, 120b, 120c, 120n positioned therein. The filler material 121 may include a potting compound. The potting compound may fill the interior region of the tube 130 with a solid or gelatinous compound for high voltage assemblies that excludes gaseous phenomena such as corona discharge, according to an embodiments. The potting compound also may provide resistance to shock and vibration, while also excluding water, moisture, or corrosive agents (e.g., from the interior region of the tube 130 and/or the sensors 120a, 120b, 120c, 120n). The potting material may be used in the interior region of the tube 130 (e.g. only in the interior region of the tube 130), and may fully encapsulate the electrical components (e.g., the PCA 123 and the sensors 120a, 120b, 120c, 120n) in the interior region of the tube 130 such that the cryogenic fluid 104 does contact the sensors 120a, 120b, 120c, 120n. The filler material 121 may also provide additional temperature buffering and may transfer at least some of the cold temperature (e.g., cold thermal energy) from the tube 130 to the sensors 120. In some embodiments, the filler material 121 comprises a conductive material capable of transferring the cold temperature (e.g., cold thermal energy).

Once the sensors 120a, 120b, 120c, 120n and the filler material 121 are positioned within the interior region of the tube 130, the tube 130 may be substantially free of open spaces or voids at least between the sensor 120a and the sensor 120n. For example, in some embodiments, the filler material 121 may extend substantially continuously in the interior region of the tube 130 from the distal end 131 to the proximal end 132 of the tube 130. In some embodiments, the filler material 121 may extend substantially continuously in the interior region of the tube 130 from at least proximate the distal end 132 (e.g., at least encompassing the sensor 120n) to at least proximate the sensor 120a (e.g., at least encompassing the sensor 120a).

The distal end 131 of the tube 130 may be closed and/or sealed. For example, the distal end 131 may include the stainless steel, metal, and/or other non-corrosive material of the outer layer of the tube 130. In some embodiments, the distal end 131 of the tube 130 may be sealed with a non-corrosive material different than the outer layer of the tube 130. The distal end 131 may be rounded. The proximal end 132 of the tube 130 may sealed to allow the wire 112 to exit the interior region of the tube 130.

The tube 130 includes a distal end 131 and a proximal end 132. The tube 130 may be substantially continuous between the distal end 131 and the proximal end 132 (e.g., holes, perforations, and openings are absent on the tube 130 between the distal end 131 and the proximal end 132 in many embodiments). The tube 130 may be substantially linear between the distal end 131 and the proximal end 132. During use of the sensing device 120, the distal end 131 may be disposed within container 102 such that the distal end is disposed at least proximate to a bottom 102a of the container 102. Accordingly, unless the container 102 is substantially empty, the distal end 131 of the tube 130 may be positioned within the cryogenic fluid 104 when the sensing device 120 is in use. In other embodiments, the distal end 131 need not extend to the bottom 102a of the container 102. Rather, the distal end 131 extends to a length that is configured to be positioned in the cryogenic fluid 104 when in use. In some embodiments, the proximal end 132 of the tube 130 is disposed at least proximate to a top 102b of the container 102 when the sensing device 120 is in use. In some embodiments, the proximal end 132 of the tube 130 is positioned above the cryogenic fluid 104 when the cryogenic fluid 104 is at a predetermined maximum level within the container 102. In other embodiments, the proximal end 132 does not extend to the top 102b of the container, but above where the cryogenic fluid 104 is intended to be in the container 102.

In some embodiments, the distal end 131 of the tube 130 may be closer to the distal most sensor (sensor 120n in FIGS. 1 and 2) than proximal most sensor (sensor 120a) is to the proximal end 132 of the tube 130. For example, in some embodiments, the distal most sensor 120n may be positioned at the distal end 131, while the proximal most sensor 120a may be spaced from the proximal end 132 of the tube 130.

The plurality of sensors in the sensing device 120 are arranged or otherwise configured to produce a single measurement. For example, the plurality of sensors may be arranged in a series circuit, a parallel circuit, or combinations thereof (e.g., a series-parallel circuit). As provided above, each sensor 120a, 120b, 120c, 120n in the sensing device 120 may be configured to sense a property relating to the cryogenic fluid 104 that changes when the cryogenic fluid 104 transitions between a liquid phase and a vapor phase. The tube 130 may reduce the amount of change in the property sensed by the plurality of sensors when the cryogenic fluid 104 around each sensor 120a-n changes phases.

In many embodiments, the system 100 is configured to provide not only an active level of the cryogenic fluid 104, but also a continuous temperature measurement of the cryogenic fluid 104. For example, the temperature sensing element 125 may include a resistance temperature detector (RTD) temperature sensing element. The temperature sensing element 125 may be disposed at the distal end 131 of the tube 130 such that this sensing element 125 remains disposed within the cryogenic fluid 104 (e.g., below the fluid line of the cryogenic fluid 104) as the cryogenic fluid 104 evaporates and other sensing elements 120 are no longer positioned within the cryogenic fluid 104 (e.g., above the fluid line of the cryogenic fluid 104). This temperature sensing element 125 may be configured to provide to the controller 110 the temperature of the cryogenic fluid 104. Thus, the resistance of the temperature sensing element 125 may be a known value when the sensing device 120 is inserted into the cryogenic fluid 104. With the data from the temperature sensing element 125, the controller 110 may be configured to report and/or respond to minor temperature deviations in the cryogenic fluid 104. When the sensing device 120 is immersed in the cryogenic fluid 104 and all elements (sensors 120a-n, 125) are immersed in the cryogenic fluid 104, the resistance of each element (sensors 120a-n) is known. Therefore, the resistance level of the elements (sensors 120a-n) must equal N times that of the temperature sensing element 125. In many embodiments, the temperature sensing element 125 also is encapsulated within the filler material 121. In the system 100 illustrated in FIG. 2, the temperature sensing element 125 is disposed at the distal end 131 of the tube 130.

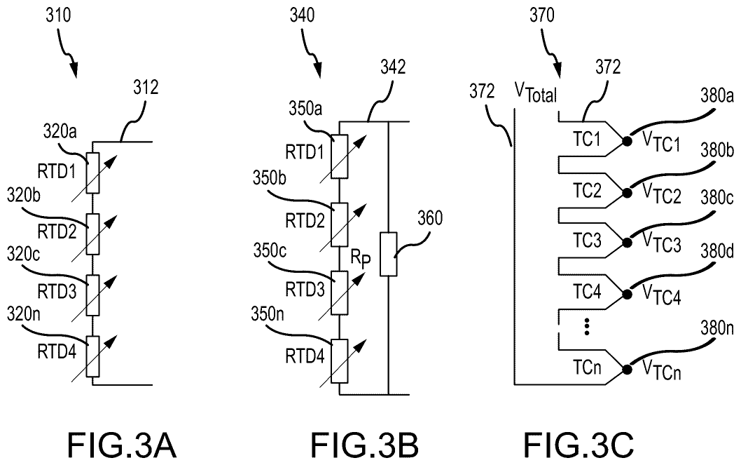

Turning now to FIG. 3A, in some embodiments, the system 100 may include a sensing device 310 having a plurality of RTDs 320a, 320b, 320c, 320n coupled via a wire 312 in a series circuit to provide a single measurement to the controller 110. In some embodiments, RTDs are used specifically with liquid oxygen and/or liquid nitrogen as the cryogenic fluid 104. Each RTD 320a, 320b, 320c, 320n in the sensing device 310 is configured to sense or detect a temperature of cryogenic fluid 104 in the liquid phase and the vapor phase.

The temperature of the cryogenic fluid is determined by the physical properties commonly used in cryogenic fluid. For example: liquid oxygen has a boiling point of −182.96° C. (−297.33° F.; 90.19 K) at 1 bar (15 psi), and a vapor temperature of −118.6° C. (−181.48° F.; 154.55 K). Liquid nitrogen has a boiling point of −195.8° C. (−320.4° F.; 77.4 K) at 1 bar (15 psi), and a vapor temperature −147.0° C. ( −232.6° F.; 126.15 K). Each RTD 320a, 320b, 320c, 320n, then, may be configured to sense or detect a temperature associated with the cryogenic fluid 104 at the vapor phase and also at the liquid phase.

Each RTD 320a, 320b, 320c, 320n senses or detects distinct differences when immersed in the liquid phase versus the vapor phase of the cryogenic fluid 104 and as buffered by the tube 130. Accordingly, each RTD 320a, 320b, 320c, 320n is configured to sense or detect at least a first temperature relating to or associated with the liquid phase of the cryogenic fluid 104, and a second temperature different from the first temperature and relating to or associated with the vapor phase of the cryogenic fluid 104. Each RTD 320a, 320b, 320c, 320n includes a resistance that correlates to the temperature sensed or detected by the RTD 320a, 320b, 320c, 320n. Thus, resistance of each RTD 320a, 320b, 320c, 320n changes between a first resistance at the first temperature when the cryogenic fluid 104 is in a liquid phase and a second resistance at the second temperature when the cryogenic fluid 104 is in a vapor phase, and as buffered by the tube 130. The summation of the resistance of the plurality of sensors in the sensing device 310 delivers a proportional response to the level of the cryogenic fluid 104. The resultant resistance is then correlated to the temperature based on the appropriate RTD temperature versus resistance table. In some embodiments, the summation of the resistance of the plurality of sensors in the sensing device 310 may be determine using a formula:

Rₜₒₜₐₗ=Σᵢ₌₁ⁿR_{RTD} (n)

Turning now to FIG. 3B, in some embodiments, the system 100 may include a sensing device 340 having a plurality of resistance temperature detectors (RTDs) 350a, 350b, 350c, 350n coupled via a wire 342 in a parallel circuit to provide a single measurement to the controller 110. Each RTD 350a, 350b, 350c, 350n in the sensing device 340 is configured to sense or detect a temperature of cryogenic fluid 104 in the liquid phase and the vapor phase. Each RTD 350a, 350b, 350c, 350n senses or detects distinct differences when immersed in the liquid phase versus the vapor phase of the cryogenic fluid 104 and as buffered by the tube 130. Accordingly, each RTD 350a, 350b, 350c, 350n is configured to sense or detect at least a first temperature relating to or associated with the liquid phase of the cryogenic fluid 104 and a second temperature different from the first temperature and relating to or associated with the vapor phase of the cryogenic fluid 104. Each RTD 350a, 350b, 350c, 350n includes a resistance that correlates to the temperature sensed or detected by the RTD 350a, 350b, 350c, 350n. Thus, resistance of each RTD 350a, 350b, 350c, 350n changes between a first resistance at the first temperature when the cryogenic fluid 104 is in a liquid phase and a second resistance at the second temperature when the cryogenic fluid 104 is in a vapor phase and as buffered by the tube 130. The summation of the resistance or temperature of the plurality of sensors in the sensing device 340 delivers a proportional response to the level of the cryogenic fluid 104. In an example, FIG. 3B demonstrates a system or method to scale the resistance of multiple RTDs 350a, 350b, 350c, 350n, thereby resulting in narrowing the resistance range of the sensing device 340. This scaling system and method in FIG. 3B may allow for a system or method that is capable of displaying a limited temperature range.

Turning now to FIG. 3C, in some embodiments, the system 100 may include a sensing device 370 having a plurality of thermocouples (TCs) 380a, 380b, 380c, 380d, 380n coupled via a wire 372 in a parallel circuit to provide a single measurement to the controller 110. Each thermocouple 380a, 380b, 380c, 380d, 380n in the sensing device 370 is configured to sense or detect a voltage (V) of cryogenic fluid 104 in the liquid phase and the vapor phase, and as buffered by the tube 130. In some embodiments, the thermocouples are used specifically with liquid helium as the cryogenic fluid 104. Each thermocouple 380a, 380b, 380c, 380d, 380n senses or detects distinct differences in voltage when immersed in the liquid phase versus the vapor phase of the cryogenic fluid 104. Accordingly, each thermocouple 380a, 380b, 380c, 380d, 380n is configured to sense or detect at least a first voltage relating to or associated with the liquid phase of the cryogenic fluid 104 and a second voltage different from the first voltage and relating to or associated with the vapor phase of the cryogenic fluid 104. Thus, voltage of each thermocouple 380a, 380b, 380c, 380d, 380n changes between a first voltage when the cryogenic fluid 104 is in a liquid phase and a second voltage when the cryogenic fluid 104 is in a vapor phase and as buffered by the tube 130. The summation of the voltage of the plurality of sensors in the sensing device 370 delivers a proportional response to the level of the cryogenic fluid 104. In an example, the summation of the voltage of the plurality of sensors of the sensing device may be determined using a formula:

Vₜₒₜₐₗ=Σᵢ₌₁ⁿV_{TC} (n)

Returning to FIGS. 1 and 2, the controller 110 is coupled to the sensing device and configured to determine an approximate level of the cryogenic fluid 104 in the container 102 based on a single measurement derived from the sensing device 120 including the plurality of sensors. The single measurement from the plurality of sensors in the sensing device 120 is derived from (e.g., a summation of) the property detected by each sensor 120a, 120b, 120c, 120n of the plurality of sensors in the sensing device 120. For example, when the plurality of sensors in the sensing device 120 includes a plurality of thermocouples, the controller 110 is configured to determine the approximate level of the cryogenic fluid 104 in the container 102 based on a single resistance measurement (e.g., a summation of resistance) derived from the plurality of thermocouples. When the plurality of sensors in the sensing device 120 include a plurality of thermocouples, the controller 110 is configured to determine the approximate cryogenic fluid 104 level in the container 102 based on a single voltage measurement (e.g., a summation of voltage) derived from the plurality of thermocouples.

The controller 110 is configured to determine approximately where the cryogenic fluid 104 level is relative to a position of one or more sensors 120a, 120b, 120c, 120n of the plurality of sensors in the sensing device 120. More specifically, the controller 110 is configured to determine approximately where the cryogenic fluid 104 level is relative to a position of two adjacent sensors of the plurality of sensors in the sensing device 120. For example, in FIG. 1, each sensor 120a, 120b, 120c, 120n is immersed in the liquid phase of the cryogenic fluid 104. Each sensor 120a, 120b, 120c, 120n, then, senses or detects a property (e.g., temperature/resistance or voltage) relating to the cryogenic fluid 104 in the liquid phase effective to result in a single measurement (e.g., resistance or voltage) for the plurality of sensors. The controller 110 is configured to use the single measurement (e.g., resistance or voltage) to determine the cryogenic fluid 104 level is above all of the sensors 120a, 120b, 120c, 120n.

Turning specifically to FIG. 2, the first sensor 102a is immersed in the vapor phase of the cryogenic fluid 104, while the sensors 120b, 120c, 120n are immersed in the liquid phase of the cryogenic fluid 104. As buffered by the tube 130, the first sensor 120a, then, senses or detects a property (e.g., temperature/resistance or voltage) more closely relating to the cryogenic fluid 104 in the vapor phase, and the sensors 120b, 120c, 120n sense or detect a property (e.g., temperature/resistance or voltage) more closely relating to the cryogenic fluid 104 in the liquid phase that is different from the property in the vapor phase. In the example of FIG. 2, the plurality of sensors produce a single measurement (e.g., resistance or voltage) based on the first sensor 120a sensing or detecting the vapor phase and the sensors 120b, 120c, 120n detecting the liquid phase, the single measure for the example of FIG. 2 being different from the single measurement produced by the sensing device 120 when each sensor 120a, 120b, 120c, 120n was immersed in the liquid phase. The controller 110 is configured to use the single measurement (e.g., resistance or voltage) from the example shown in FIG. 2 to determine the cryogenic fluid 104 level is above the sensors 120b, 120c, 120n, but below the sensor 120a. Accordingly, the controller may use the single measurement from the example shown in FIG. 2 to determine the cryogenic fluid 104 level is between the first sensor 120a and the second sensor 120b. Further, as the positions of the sensors 120a, 120b, 120c, 120n in the container 102 is known or predetermined, the position of the cryogenic fluid 104 is also known relative to the sensors 120a, 120b, 120c, 120n.

Conventional systems utilizing multiple sensors may result in a “stair step” reading that changes only when the phase of the cryogenic fluid around a sensor changes from liquid to vapor. This reading in conventional systems, then, does not allow a user to determine with precision the level of the cryogenic fluid between two adjacent sensors. The tube 130 of the sensing device 120, however, is configured to distribute the cold temperature (e.g., cold thermal energy) of the cryogenic fluid 104 along a length of the tube 130 and act as a buffer between the cryogenic fluid 104 and the sensors 120a-n. As the sensors 120a-n are encapsulated within the tube 130 mechanically, the tube 130 acts as the single sensing element 120, according to an embodiment. Thus, the combination of the sensors 120a-n disposed within the core of the tube 130 allows a user to obtain a more linear or smooth curve reading of the level of the cryogenic fluid 104 in the container 102. Thus, the positioning of the of the sensors 120a-n in the tube 130 with the filler material 121 allows a user to more accurately determine the level of the cryogenic fluid 104 when the cryogenic fluid is at a level in the container 102 between two adjacent sensors of the sensors 120a-n.

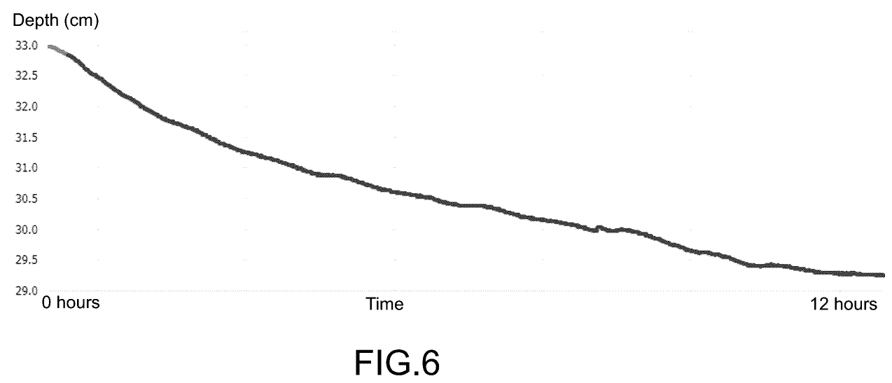

Turning ahead in the drawings, FIG. 6 is a graph of the reported depth of a cryogenic fluid using the system 100 of FIGS. 1 and 2, according to an embodiment. The controller 110 may be configured to produce a graph, such as the graph of FIG. 6, that is an example reported depth of the cryogenic fluid 104 (in centimeters on the x axis) over time (on the y axis) using an embodiment the sensing element 120 and the system 100 is shown. Rather than the “stair-step” readings of conventional systems including multiple sensors, the combination of embodiments of the sensors 120a-n, the tube 130, and the system 100 as described herein allow the controller 110 to provide a more smooth-curved reported depth over time. The resolution of the resulting graph is sufficient to discern the level of the cryogenic fluid 104 with sufficient detail. For example, as described above, the tube 130 acts as a buffer between the cryogenic fluid 104 and the sensors 120a-n, and distributes the cold temperature (e.g., cold thermal energy) along the tube 130. This configuration of the tube 130 reduces the amount of change in the property sensed by the sensors 120a-n when the cryogenic fluid 104 around each sensor 120a-n changes from liquid to vapor, and the controller may utilize the continuously or more regularly changing single measurement to produce a substantially smooth curve or linear graph of the depth of the cryogenic fluid 104 in the container 102. In some embodiments, depending on the configuration of the container 102 and/or the conditions of storage of the container 102, the controller 100 may produce a graph of the depth of the cryogenic fluid 104 in the container 102 that has other smoothed orientations, such as a smooth arc-like curve or a parabola. Thus, the buffering configuration of the tube 130 allows the controller 110 to use observed data to determine with more precision a depth of the cryogenic fluid 104 in the container 102 in real time, even when the level of the cryogenic fluid 104 is between adjacent sensors of the sensors 120a-n.

Within the system 100, there may be three conditions or states: (1) all sensors 120a-n are fully immersed in the cryogenic fluid 104 (all sensors 120a-n read substantially the same resistance (temperature) value in this condition); (2) all sensors 120a-n are fully exposed to the cryogenic vapor (all sensors 120a-n read substantially the same resistance (temperature) value in this condition); and (3) one or more sensors 120a-n are in the cryogenic fluid 104, and one or more sensors 120a-n are in the vapor (the one or more sensors 120a-n in the cryogenic fluid 104 read a different resistance (temperature) than the one or more sensors in the vapor). The data returned for states (1) and (2) may be observed as a substantially constant value. In state (3), the buffering action of the tube 130 of the sensing device 120 may improve performance of the system 100. For example, the thermal buffering of the tube 130 may provide a substantially homogeneous environment between the transition zone between the sensors described in (3).

The result of the buffering by the tube 130 may be to change readings that would be normally viewed as a sharp transition (stair step) to a smoothed, linear-like curve. If, for example the sensors were placed a fixed distance apart, the level response of an unbuffered solution would be a stair step between each transition from liquid to vapor at each sensor. The resolution of the depth measurement would only be that of the distance between the sensors. By adding the thermal buffer of the tube 130, the transition from fluid to vapor can be determined. This determination results in a very high-resolution rendering of the transition of the level measurement and affords a smoother line to return an accurate level measurement. This approach is more cost effective and reasonable than the alternative of spacing the sensors infinitely closely to gain the exact resolution of the thermally buffered model. Thus, the approximate height of the cryogenic fluid 104 (e.g., the cryogenic fluid level) between adjacent sensors of the sensors 120a-n can be detected and determined at any given time or height. More specifically, an approximate height of the cryogenic fluid 104 between adjacent sensors of sensors 120a-n can be detected and determined at any given time—even when the cryogenic fluid 104 is transitioning between the liquid phase and the vapor phase at a non-linear rate and/or the height of the cryogenic fluid 104 in the container 102 is changing at a non-linear rate.

In contrast, systems and methods utilizing the “stair step” approach are relatively limited in estimating the height of the cryogenic fluid between adjacent sensors. For example, conventional systems and methods for detecting the height of the cryogenic fluid in a container can be essentially blind between adjacent sensors, while embodiments of the system 100 are configured to determine a height of the cryogenic fluid 104 in the container 102 between adjacent sensors of the sensors 120a-n based on observed data from the sensors 120a-n.

As provided above, in many embodiments, the result of the buffering by the tube 130 and the filler material is a smoothed, linear-like curve rather than a sharp transition (stair step) in the graph. This smooth curve or “damping” effects of the tube 130 and/or potting material encapsulated the sensors 120a-n may be modeled mathematically. In many embodiments, the temperature response that results from encapsulation in a single tube. For this example, the described temperature and sensor array resistance are directly proportional. In a non-limiting example, a sensing element of multiple sensing devices (e.g., sensors 120a-n) spaced at equal distances is arranged on a printed circuit board and encapsulated into a tube (e.g., tube 130). For this example, the sensing array comprises five (5) sensing devices (PT100) spaced 2.5 cm apart.

In conventional systems, the response of the sensing devices is equal to the sum of each sensing element. For example:

$$RT = {\sum }_{i}^{n} Ri$$

In the proposed example using five sensing elements, then:

$$RT = {\sum }_{1}^{5} Ri$$

The resultant measurement is evident with all five elements in the cryogenic fluid. As the first element is exposed to the vapor temperature, the resistance will change by 10% or more. Liquid nitrogen's temperature change will be from −197° C. to −170° C. This transition results in the stair step graph.

In contrast, a non-limiting example of the embodiment may have a linear response as the sensing elements transition through the liquid to vapor phase. The following equations describe the temperature response of two sensing elements of the five sensing elements:
Element N—in cryogenic fluid.
Element N+1—transitioning from liquid to vapor phase of the cryogenic phase.

As the multiple sensing elements are mechanically encapsulated into a tube and potting material, the multiple sensing elements may act as a single sensing element. The following equation describes the response of the sensing elements that are in transition.

y(t)=T(t)−Tα Temperature difference between medium and vapor temperature

yo=T(0)−Tα=To−Tα Initial temperature difference at t=0 (transition)

$$\frac{dy}{dt} = \frac{d}{dt} ( T ( t ) - T α ) = \frac{dT}{dt} - \frac{dT α}{dt} = \frac{dT}{dt} = - k ( T - T α ) = - ky$$

$$\frac{dy}{dt} = - ky$$

$$\frac{\frac{dy ( t )}{dt}}{y ( t )} = - k$$

$$\int \frac{\frac{dy ( t )}{dt}}{y ( t )} dt = \int - k dt$$

$$ln ( y ( t ) = - kt + c = c - kt$$

$$( y ( t ) = {e}^{C - kt}$$

$$( y ( t ) = ce - kt$$

$$T ( t ) - T α = ( To - T α ) {e}^{- kt}$$

$$T ( t ) = T α + ( To - T α ) {e}^{- kt}$$

The above equation describes the dampening or smoothing effect of the encapsulated sensing element. When adjacent sensing elements are in the liquid medium To=Tα. Then: T(t)=Tα. This equation applies when sensing elements switch between liquid and vapor phases. The resistance response R(t) is calculated as:

$$R ( i ) = Rv + ( R ∇ - Rv ) {e}^{- kt}$$

Where: R(t)=resistance between two elements that are between media layers (liquid and vapor), Rv=resistance of the element in the vapor, RΛ=resistance of the element in the liquid, k=constant based on the thermal characteristics of the sensing element, and t=time.

In some embodiments, the controller 110 is configured to determine a rate of change of the cryogenic fluid from the liquid phase to the vapor phase using a rate of change between the detected properties of adjacent sensors. For example, the time between transition steps at each sensor 120a, 120b, 120c, 120n is a measure of the rate of depth change. When plotted, the resultant slope of the resistance/temperature or voltage may be used to compute the rate of change of the liquid loss in the cryogenic fluid 104. In some embodiments, the slope may be computed from each of the sensors 120a, 120b, 120c, 120n measuring the temperature or voltage. In some embodiments, the slope maybe reverse computed by converting the temperature from independent sensors to resistance, the resistance summed and converted to temperature. The temperatures or voltages may be plotted and the slope determined. In some embodiments, readings or measurements from the plurality of sensors in the sensing device 120 may be translated into independent analog to digital conversion devices for evaluation or use a single analog to digital conversion. In some embodiments, the slope can generally match the linear line detected.

In some embodiments, the controller 110 is configured to coordinate an alert indicating that the cryogenic fluid 104 level is below a predetermined threshold. In some embodiments, the alert is coordinated and generated by the controller 110. In some embodiments, the controller 110 communicates with one or more electronic devices which generate an alert indicating that cryogenic fluid 104 level is below a predetermined threshold. For example, a predetermined threshold may include the cryogenic fluid 104 level being at or above the second sensor 120c from the bottom. When the controller 110 uses the single measurement from the sensing device 120 to determine the second sensor 120c from the bottom is immersed in the vapor phase rather than the liquid phase of the cryogenic fluid 104, the controller 110 may coordinate an alert. The predetermined threshold can be at any point and need not be at the location of a sensor because the system 100 can detect a height of the cryogenic fluid 104 between adjacent sensors of the sensors 120a-n.

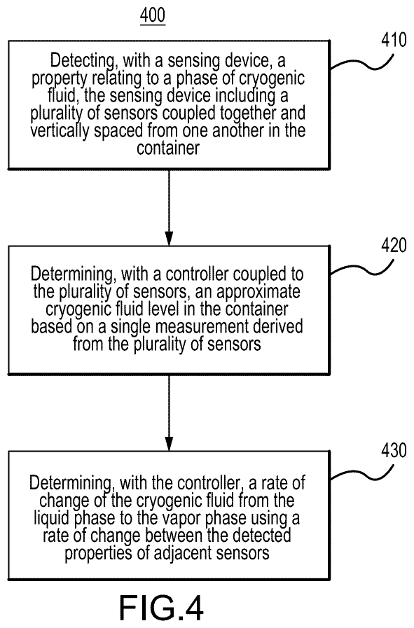

Turning now to FIG. 4, a method 400 for detecting a cryogenic fluid level in a container. The method 400 may include any aspect or acts of the system 100, the controller, and the sensing devices 120, 310, 340, 370 described above. In some embodiments, the method 400 includes an act 410 of detecting, with a sensing device, a property relating to a phase of cryogenic fluid, the sensing device including a plurality of sensors coupled together and vertically spaced from one another in the container. The method 400 also may include an act 420 of determining, with a controller coupled to the plurality of sensors, an approximate cryogenic fluid level in the container based on a single measurement derived from the plurality of sensors. The method 400 may optionally include an act 430 of determining, with the controller, a rate of change of the cryogenic fluid from the liquid phase to the vapor phase using a rate of change between the detected properties of adjacent sensors.

In some embodiments, the single measurement from the plurality of sensors is derived from the property detected by each sensor of the plurality of sensors. The act 420 may include determining approximately where the cryogenic fluid level is relative to a position of one or more sensors of the plurality of sensors. For example, the act 420 may include determining approximately where the cryogenic fluid level is relative to a position of two adjacent sensors of the plurality of sensors.

In some embodiments, the act 410 may include detecting with each sensor of the plurality of sensors, a property relating to the cryogenic fluid that changes when the cryogenic fluid transitions between a liquid phase and a vapor phase. More specifically, the act 410 may include detecting, with a plurality of RTDs, one of a first temperature relating to the liquid phase of the cryogenic fluid and a second temperature relating the vapor phase of the cryogenic fluid, wherein resistance of each RTD of the plurality of RTDs changes between a first resistance at the first temperature and a second resistance at the second temperature. In these and other embodiments, the act 420 may include determining, with the controller, the approximate cryogenic fluid level in the container based on a single resistance measurement derived from the plurality of RTDs.

In some embodiments, the act 410 may include detecting, with a plurality of thermocouples, one of a first voltage relating the liquid phase of the cryogenic fluid and a second voltage relating to the vapor phase of the cryogenic fluid. In these and other embodiments, the act 420 may include determining, with the controller, the approximate cryogenic fluid level in the container based on a single voltage measurement derived from the plurality of thermocouples.

In some embodiments of the method 400, the plurality of sensors are coupled together in one of a series circuit, a parallel circuit, or a series-parallel circuit. In some embodiments of the method 400, the plurality of sensors includes at least three sensors, and each sensor of the plurality of sensors is spaced an equal distance from an adjacent sensor of the plurality of sensors.

Acts of the method 400 are for illustrative purposes. For example, the acts of the method 400 may be performed in different orders, split into multiple acts, modified, supplemented, or combined. Any of the acts of the method 400 may include using any of the systems, sensing devices, sensors, controllers, or containers disclosed herein.

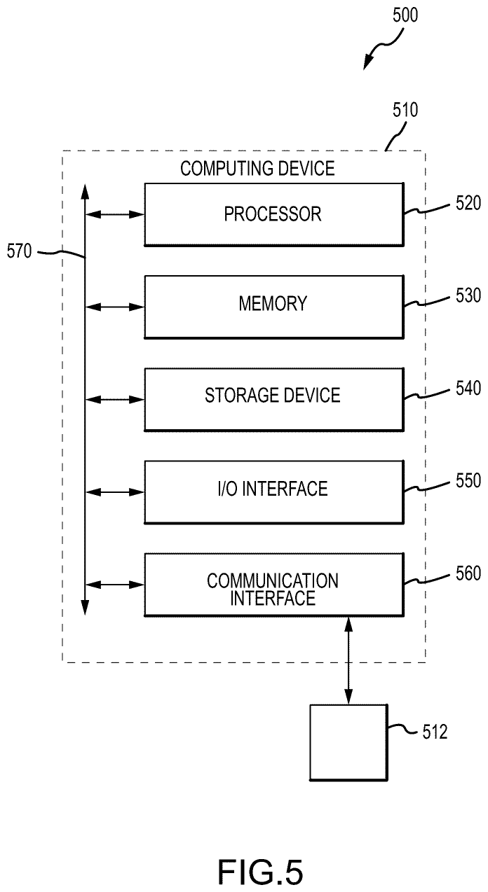

Any of the example systems disclosed herein may be used to carry out any of the example methods disclosed herein, such as using a controller. FIG. 5 is a schematic of a controller 500 for use in any of the system disclosed herein and/or executing any aspects of the example methods disclosed herein, according to an embodiment. Accordingly, the controller 110 may include any aspect of the controller 500. The controller 500 may be configured to implement any of the example methods disclosed herein, such as one more acts of the method 400 and/or one or more acts of the controller 110 in the system 100. The controller 500 includes at least one computing device 510. The at least one computing device 510 is an exemplary computing device that may be configured to perform one or more of the acts described above, such as one or more acts of the method 400 and/or one or more acts of the controller 110 in the system 100. The at least one computing device 510 can include one or more servers, one or more computers (e.g., desk-top computer, lap-top computer), or one or more mobile computing devices (e.g., smartphone, tablet, etc.). The computing device 510 can comprise at least one processor 520, memory 530, a storage device 540, an input/output (“I/O”) device/interface 550, and a communication interface 560. While an example computing device 510 is shown in FIG. 5, the components illustrated in FIG. 5 are not intended to be limiting of the controller 500 or computing device 510. Additional or alternative components may be used in some examples. Further, in some examples, the controller 500 or the computing device 510 can include fewer components than those shown in FIG. 5. For example, the controller 500 may not include the one or more additional computing devices 512. In some examples, the at least one computing device 510 may include a plurality of computing devices, such as a server farm, computational network, or cluster of computing devices. Components of computing device 510 shown in FIG. 5 are described in additional detail below.

In some examples, the processor(s) 520 includes hardware for executing instructions (e.g., instructions for carrying out one or more portions of any of the methods disclosed herein), such as those making up a computer program. For example, to execute instructions, the processor(s) 520 may retrieve (or fetch) the instructions from an internal register, an internal cache, the memory 530, or a storage device 540 and decode and execute them. In particular examples, processor(s) 520 may include one or more internal caches for data such as look-up tables. As an example, the processor(s) 520 may include one or more instruction caches, one or more data caches, and one or more translation lookaside buffers (TLBs). Instructions in the instruction caches may be copies of instructions in memory 530 or storage device 540. In some examples, the processor 520 may be configured (e.g., include programming stored thereon or executed thereby) to carry out one or more portions of any of the example methods disclosed herein.

In some examples, the processor 520 is configured to perform any of the acts disclosed herein such as in the method 400 or associated with the controller 110, or cause one or more portions of the computing device 510 or controller 500 to perform at least one of the acts disclosed herein. Such configuration can include one or more operational programs (e.g., computer program products) that are executable by the at least one processor 520. For example, the processor 520 may be configured to automatically determine an approximate cryogenic fluid level in the container based on a single measurement derived from the plurality of sensors, determine a rate of change of the cryogenic fluid from the liquid phase to the vapor phase using a rate of change between the detected properties of adjacent sensors, and/or coordinate an alert when the cryogenic fluid drops below a predetermined level.

The at least one computing device 510 (e.g., a server) may include at least one memory storage medium (e.g., memory 530 and/or storage device 540). The computing device 510 may include memory 530, which is operably coupled to the processor(s) 520. The memory 530 may be used for storing data, metadata, and programs for execution by the processor(s) 520. The memory 530 may include one or more of volatile and non-volatile memories, such as Random Access Memory (RAM), Read Only Memory (ROM), a solid state disk (SSD), Flash, Phase Change Memory (PCM), or other types of data storage. The memory 530 may be internal or distributed memory.

The computing device 510 may include the storage device 540 having storage for storing data or instructions. The storage device 540 may be operably coupled to the at least one processor 520. In some examples, the storage device 540 can comprise a non-transitory memory storage medium, such as any of those described above. The storage device 540 (e.g., non-transitory storage medium) may include a hard disk drive (HDD), a floppy disk drive, flash memory, an optical disc, a magneto-optical disc, magnetic tape, a Universal Serial Bus (USB) drive, or a combination of two or more of these. Storage device 540 may include removable or non-removable (or fixed) media. Storage device 540 may be internal or external to the computing device 510. In some examples, storage device 540 may include non-volatile, solid-state memory. In some examples, storage device 540 may include read-only memory (ROM). Where appropriate, this ROM may be mask programmed ROM, programmable ROM (PROM), erasable PROM (EPROM), electrically erasable PROM (EEPROM), electrically alterable ROM (EAROM), flash memory, or a combination of two or more of these. In some examples, one or more portions of the memory 530 and/or storage device 540 (e.g., memory storage medium(s)) may store one or more databases thereon.

In some examples, data used in any of the systems and methods described herein may be stored in a memory storage medium such as one or more of the at least one processor 520 (e.g., internal cache of the processor), memory 530, or the storage device 540. In some examples, the at least one processor 520 may be configured to access (e.g., via bus 570) the memory storage medium(s) such as one or more of the memory 530 or the storage device 540. For example, the at least one processor 520 may receive and store the data (e.g., look-up tables) as a plurality of data points in the memory storage medium(s). The at least one processor 520 may execute programming stored therein adapted access the data in the memory storage medium(s) to automatically determine an approximate cryogenic fluid level in the container based on a single measurement derived from the plurality of sensors, determine a rate of change of the cryogenic fluid from the liquid phase to the vapor phase using a rate of change between the detected properties of adjacent sensors, and/or coordinate an alert when the cryogenic fluid drops below a predetermined level.

The computing device 510 also includes one or more I/O devices/interfaces 550, which are provided to allow a user to provide input to, receive output from, and otherwise transfer data to and from the computing device 510. These I/O devices/interfaces 550 may include a mouse, keypad or a keyboard, a touch screen, camera, optical scanner, network interface, web-based access, modem, a port, other known I/O devices or a combination of such I/O devices/interfaces 550. The touch screen may be activated with a stylus or a finger.

The I/O devices/interfaces 550 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 550 are configured to provide graphical data to a display for presentation to a user. The graphical data may be representative of one or more graphical user interfaces and/or any other graphical content as may serve a particular implementation.

The computing device 510 can further include a communication interface 560. The communication interface 560 can include hardware, software, or both. The communication interface 560 can provide one or more interfaces for communication (such as, for example, packet-based communication) between the computing device 510 and one or more additional computing devices 512 or one or more networks. For example, communication interface 560 may include a network interface controller (NIC) or network adapter for communicating with an Ethernet or other wire-based network, a wireless NIC (WNIC) or wireless adapter for communicating with a wireless network, such as a WI-FI.

Any suitable network and any suitable communication interface 560 may be used. For example, computing device 510 may communicate with an ad hoc network, a personal area network (PAN), a local area network (LAN), a wide area network (WAN), a metropolitan area network (MAN), or one or more portions of the Internet, or a combination of two or more of these. One or more portions of one or more of these networks may be wired or wireless. As an example, one or more portions of controller 500 or computing device 510 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 510 may include any suitable communication interface 560 for any of these networks, where appropriate.

The computing device 510 may include a bus 570. The bus 570 can include hardware, software, or both that couples components of computing device 510 to each other. For example, bus 570 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

It should be appreciated that any of the examples of acts of the controller 110 in the system 100 or the method 400 described herein may be performed by and/or at the computing device 510.

### EXAMPLE 1

In an example, a sensing device including multiple RTD sensors (Pt100 RTD sensors) cascaded in series, as shown in FIG. 3A. The multiple RTD sensors were assembled into a single tube with the RTD sensors spaced equally from adjacent sensors. The basic functionality of an RTD is based on the principle that metal resistance will increase or decrease in relation to temperature. A temperature, then, was determined based on a specific resistance (and a specific resistance may be determined based on a specific temperature). Standards, such as IEC 60751, were used to determine temperature/resistance profiles. These temperature/resistance profiles were then be used to determine a resistance value relevant to a particular temperature.

Liquid nitrogen measurements were accomplished in a lab setting (Boise, ID—altitude 2,700 feet). The liquid nitrogen fluid was allowed to evaporate naturally. The resistance calculations in Table 1 are based on IEC 60751 profiles and allow a resistance value to be calculated based on a temperature input.

TABLE 1
RTD Resistance In Liquid Nitrogen States

| State | Temp, ° C. | Resistance, Ω |
|---|---|---|
| Fluid | −197.5 | 19.6 |
| Vapor | −164.6 | 33.65 |

Table 2 is the cascaded RTD resistance versus the temperature of the four RTD sensors.

TABLE 2
Cascaded RTD Resistance vs. Temperature of Four Sensors

| | Resistance, Ω | | | | | Reported |
|---|---|---|---|---|---|---|
| | Probe | | | | Total | Temp, |
| State | RTD1 | RTD2 | RTD3 | RTD4 | Sum | ° C. |
| Fully Immersed | 19.6 | 19.6 | 19.6 | 19.6 | 78.4 | −57.9 |
| 75% Immersed | 33.65 | 19.6 | 19.6 | 19.6 | 92.5 | −20.1 |
| 50% Immersed | 33.65 | 33.65 | 19.6 | 19.6 | 106.5 | 17.4 |
| 25% Immersed | 33.65 | 33.65 | 33.65 | 19.6 | 120.6 | 55.2 |

The resistance of the cascaded sensor is represented by:

Rₜₒₜₐₗ=Σᵢ₌₁ⁿR_{RTD} (n)

That is, the summation of the resistance of each cascaded RTD sensor is realized as the total resistance, thus representing the temperature of the material being measured. Results of the implementation of the four element cascaded RTD sensors demonstrated a change in the single temperature measurement as the cryogenic fluid changed from a liquid phase to a vapor phase at each sensor of the multiple RTD sensors. It was further observed that computing the slope of the change in the single temperature measurement and noting the rate of change, the rate of loss of liquid nitrogen may be determined.

### EXAMPLE 2

In an example, a prototype was assembled using two RTD sensors in a sensing device coupled to produce a single measurement. In the demonstrated response from the two RTD sensors, the level transition was visible for each of the three stages (e.g., both sensors immersed in the fluid phase of the liquid nitrogen; one sensor immersed in the fluid phase of the liquid nitrogen and one sensor in the vapor phase of the liquid nitrogen; and both sensors in the vapor phase of the liquid nitrogen, shown in Table 3). It was observed that the slope of the temperature profile became much more pronounced. The temperature transition and slope data became a source of information to compute the use over time of the nitrogen levels.

TABLE 3
Cascaded RTD Resistance vs.
Temperature, Two RTD Sensors

| State | RTD1 | RTD2 | Temp | Actual |
|---|---|---|---|---|
| Fully Immersed | 19.6 | 19.6 | −150 | −148.7 |
| 50% Immersed | 33.65 | 19.6 | −117 | −123.6 |
| 0% Immersed | 33.65 | 33.65 | −81 | −71.5 |

The graphed temperature of the single temperature measurement from the two RTD sensors resulted in a pronounced slope. This slope determination was be accomplished via physical measurements or reverse computation. The slope that results from the temperature measurement is the desired outcome from this system. The novelty of a single sensing probe comprised of n sensing elements provides the end result. Given the desired outcome is the slope of the temperature, the same outcome can be accomplished using two independent sensors measuring the temperature. By recording the temperatures of the two independent sensors, the temperature value was converted to the resistance of the RTD sensor. The resistance of each independent RTD sensor was summed and that value was converted to temperature, as shown in Table 4.

TABLE 5
Reverse Computation

| State | T_{RTD1} | T_{RTD2} | R_{RTD1} | R_{RTD2} | R_{Total} | Temp |
|---|---|---|---|---|---|---|
| Fully Immersed | −197 | −197 | 21.5 | 21.5 | 43.0 | −148.7 |
| 50% Immersed | −160 | −197 | 35.5 | 21.5 | 57.0 | −109 |
| 0% Immersed | −160 | −160 | 35.5 | 35.5 | 71.0 | −78 |

As used herein, the term “about” or “substantially” refers to an allowable variance of the term modified by “about” by ±10% or ±5%. Further, the terms “less than,” “or less,” “greater than,” “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

What is claimed is:

1. A system for detecting a cryogenic fluid level in a container, the system comprising:
a sensing device including a tube having a plurality of sensors disposed therein, each sensor of the plurality of sensors being configured to detect a property relating to a phase of cryogenic fluid, the plurality of sensors being coupled together and vertically spaced from one another when positioned in the container, wherein the tube encloses the plurality of sensors effective to prevent cryogenic fluid from contacting the plurality of sensors and includes a metal, stainless steel, and/or non-corrosive material configured to distribute a cold temperature along a length of the tube and act as a temperature buffer between the cryogenic fluid and the plurality of sensors when the tube is positioned within the cryogenic fluid; and
a controller coupled to the sensing device and configured to determine an approximate cryogenic fluid level in the container based on a single measurement derived from the plurality of sensors.

2. The system of claim 1, wherein the single measurement from the plurality of sensors is derived from the property detected by each sensor of the plurality of sensors.

3. The system of claim 1, wherein the controller is configured to determine an approximate depth of the cryogenic fluid in the container.

4. The system of claim 3, wherein the controller is configured to determine the approximate depth of the cryogenic fluid in real time.

5. The system of claim 1, wherein each sensor of the plurality of sensors is configured to sense a property relating to the cryogenic fluid that changes when the cryogenic fluid transitions between a liquid phase and a vapor phase.

6. The system of claim 5, wherein the controller is configured to determine a rate of change of the cryogenic fluid from the liquid phase to the vapor phase using a rate of change between the detected properties of adjacent sensors.

7. The system of claim 1, wherein the plurality of sensors includes at least three sensors and each sensor of the plurality of sensors is spaced an equal distance from an adjacent sensor of the plurality of sensors.

8. The system of claim 1, wherein the tube includes an outer layer of metal, stainless steel, and/or a non-corrosive material defining an interior region of the tube, and the plurality of sensors are positioned within a filler material within the interior region of the tube.

9. The system of claim 8, wherein the outer layer of the tube is substantially continuous such that holes, openings, and/or perforations are absenting from the outer layer of the tube, and wherein the filler material extends substantially continuous in the interior region from a distal most sensor of the plurality of sensors to a proximal most sensor of the plurality of sensors.

10. The system of claim 8, wherein the tube includes a distal end that is closed and configured to be positioned within the cryogenic fluid.

11. The system of claim 1, wherein the controller is configured to determine the approximate cryogenic fluid level when the cryogenic fluid level is between adjacent sensors of the plurality of sensors.

12. The system of claim 11, wherein the controller is configured to determine the approximate cryogenic fluid level when the cryogenic fluid level is between adjacent sensors of the plurality of sensors and the cryogenic fluid is transitioning from a liquid phase to a vapor phase at a non-linear rate.

13. A method for detecting a cryogenic fluid level in a container, the method comprising:
detecting, with a sensing device, a property relating to a phase of cryogenic fluid, the sensing device including a plurality of sensors coupled together and vertically spaced from one another within a tube positioned in the container, the tube preventing the cryogenic fluid from contacting the plurality of sensors, distributing a cold temperature along a length of the tube, and acting as a buffer between the cryogenic fluid and the plurality of sensors positioned therein; and
determining, with a controller coupled to the plurality of sensors, a cryogenic fluid level in the container based on a single measurement derived from the plurality of sensors.

14. The method of claim 13, wherein the single measurement from the plurality of sensors is derived from the property detected by each sensor of the plurality of sensors.

15. The method of claim 13, wherein determining an approximate cryogenic fluid level in the container includes determining, in real time, the approximate cryogenic fluid level in the container.

16. The method of claim 13, wherein detecting, with a plurality of sensors, a property relating to a phase of cryogenic fluid includes detecting with each sensor of the plurality of sensors, a property relating to the cryogenic fluid that changes when the cryogenic fluid transitions between a liquid phase and a vapor phase.

17. The method of claim 16, further comprising determining, with the controller, a rate of change of the cryogenic fluid from the liquid phase to the vapor phase using a rate of change between the detected properties of adjacent sensors.

18. The method of claim 13, wherein the plurality of sensors includes at least three sensors and each sensor of the plurality of sensors is spaced an equal distance from an adjacent sensor of the plurality of sensors.

19. The method of claim 13, wherein determining a cryogenic fluid level in the container based on a single measurement derived from the plurality of sensors includes:
determining, with the controller, the cryogenic fluid level based on the single measurement derived from the plurality of sensors when the cryogenic fluid level is between adjacent sensors of the plurality of sensors.

20. The method of claim 19, wherein determining, with the controller, the cryogenic fluid level based on the single measurement derived from the plurality of sensors when the cryogenic fluid level is between adjacent sensors of the plurality of sensors includes:
determining, with the controller, the cryogenic fluid level based on the single measurement derived from the plurality of sensors when the cryogenic fluid level is between adjacent sensors of the plurality of sensors and the cryogenic fluid is transitioning from a liquid phase to a vapor phase at a non-linear rate.
